(19) United States
(12) Patent Application Publication
(10) Pub. No.: US 2017/0339942 A1
(43) Pub. Date: Nov. 30, 2017

(54) LIGHT WEIGHT CUSTOMIZABLE ANIMATED DECOY

(71) Applicant: Steven Lawrence Van Grinsven, Potomac, MT (US)

(72) Inventor: Steven Lawrence Van Grinsven, Potomac, MT (US)

(73) Assignee: Steven Lawrence Van Grinsven, Potomac, MT (US)

(21) Appl. No.: 15/001,041

(22) Filed: Jan. 19, 2016

(51) Int. Cl. A01M 31/06

(52) U.S. Cl. CPC A01M 31/06

(57) ABSTRACT

The invention pertains to the field of decoys used for hunting, nature photography and/or game control. More particularly, the invention pertains to motor controlled, easily customizable, maintainable and light weight animated decoys.

### BACKGROUND OF THE INVENTION

The use of decoys to attract animals is well known to hunters, photographers and nature enthusiasts to attract a large variety of animal species. Traditionally, such decoys have been made as inanimate structures positioned in appropriate locations such that they attract the animal of interest, thereby increasing the chances of a successful encounter. Though the invention can apply to a number of animal attraction activities, such as photography, animal studies and nature observation, this disclosure will speak primarily to hunting.

With respect to wildfowl, such as geese, it has been observed that animated decoys more readily attract wildfowl to a target zone than do inanimate decoys. However, fowl, and in particular geese, are known to adapt to changes in their environment, and in response to increased hunting pressure many fowl have become more cautious in their behavior and are less likely to be attracted by stationary decoys. It appears that many fowl have learned to distinguish the difference between live birds and stationary decoys. The primary difference between live birds and traditional decoys is motion. Live fowl, to a large extent, exhibit movement; bobbing their heads, waddling, moving their wings, ruffling their feathers, and motions common to an animal interacting with its environment.

Though this disclosure primarily refers to goose decoys as examples, the teachings are applicable to other animal decoy systems. The description of goose decoys should not be construed as a limitation, rather as an example to better expound the teachings of this disclosure. Goose decoys come in three main types; shell decoys, full body decoys and windsock decoys. Shell decoys and full body decoys are produced to look like geese and are available in a variety of naturally occurring positions such as sitting, feeding, standing and walking positions. Windsock decoys utilize wind to both inflate the tubular decoy and offer animation due to the wind passing through the sock, which offers both inflation and animation.

A number of different types of animated decoys have been developed over time. In some embodiments, decoy designs have incorporated the use of a cord or string attached to a moveable portion of the decoy. Using this approach, a hunter can pull on said string creating a motion from that portion of the decoy. Though this approach does result in animation, it requires the hunter to be relatively close to the decoy and is not practical when a large amount of decoys are used. For example, when hunting geese, a hunter will commonly set out a plurality of decoys, commonly termed a spread. Such spreads normally number in the 100's of decoys and spreads numbering 10,000 decoys are not unheard of. Spreads vary in pattern but in all cases endeavor to appear natural to the species being hunted.

More complex decoys include the use of motors to actuate certain portions of the body. For example, GB 2 412 560, discloses a wildfowl decoy mounted on a vertical shaft that is inserted into the ground. An external motor is used to impart vertical motion to the head region as well as a pivoting motion for the entire body. U.S. Pat. No. 7,627,977 describes an animated wildfowl decoy in the shape of a turkey having two internal servo motors providing a reciprocal vertical motion to the head and a fanning motion to the tail feathers. This decoy has an internal power supply and a radio frequency receiver designed to respond to inputs from a radio frequency transmitter. U.S. Pat. No. 6,901,693 describes a decoy including a decoy body bifurcated into a forward portion and a rear portion, one or more motors, and an optional support member. This patent describes a method by which the motors produce movements using a programmable modulator or a multi-cycle remote control. U.S. Pat. No. 6,643,971 describes a decoy that simulates a waterfowl rotating to a feeding position. This patent application teaches animation produced by using a motor and torque enhanced axle located outside the body, remote control receiver, battery and a decoy mounting post. U.S. Pat. No. 6,339,893 describes an apparatus for adding movable wings and feet to a conventional hollow waterfowl decoy including a battery powered electric motor. U.S. Pat. No. 5,960,577 describes an animated hunting decoy drive system designed to fit within a decoy's body and provide movement to appendages. The drive system comprises a battery-operated DC motor that provides reciprocating motion. U.S. Pat. No. 6,212,816 describes a remote controlled animated bird decoy capable of providing oscillating motion. This method utilizes a remote controlled battery-operated motor and memory bank programmed to provide horizontal oscillatory motions. U.S. Pat. No. 4,845,873 patent describes a duck decoy incorporating an electric motor coupled to Wing appendages for producing a flapping motion thereof. Various other patents have been granted in the past that incorporate either an electric motor or a string mechanism manipulated by the hunter to produce animation, such as wing and/or head movement.

The above devices tend to be very complex to build, maintain and amend in the field to better match the natural environment. Further, the above described technologies are singular use in that they are integrated into a single decoy without the ability to easily adapt to subsequent decoy systems. Additionally the above devices tend to be large and heavy, limiting the amount of motion devices that can be practically used without undue effort and resources. These aspects have been largely overlooked by the industry and present an unmet need. Particularly, many hunters, photographers and nature enthusiasts have an interest in a variety of species and the ability to use a single motorized system to animated different decoys and different decoy types are not presently offered. Further, the above described technologies do not easily enable individual customization of animation on a case by case basis. Further yet, none of the present art offers an animation system compatible with windsock type decoys. Resolution to these shortcomings and further owner benefits are offered in the technology taught in this patent disclosure.

### SUMMARY OF THE INVENTION

The present invention is a simple and effective lightweight customizable animation system for decoys capable of being customized by a user and easily transferable from one decoy to another. The decoy contains at least one electrically driven motor powered by an electrical generating source, such as battery. An electrical circuit manages the power and actuation sequences to the motor. The decoy is mounted on a mounting bar that can be pushed into the ground or on a base, positioned on the ground situated at a location and angle chosen by a user. The motor assembly, which includes the motor, electrical generating source and electrical circuit, is mounted on the same mounting bar as the decoy unto which it acts upon. The motor assembly is mounted on the mounting bar at a vertical height chosen by the user and can be readily adjusted from one height to another. In some embodiments, the motor unit mounting facilitates choice of angle relative to the mounting bar. That is, a user can change or adjust the angle of the motor unit relative to the mounting bar thereby enabling a vast array of possible decoy movements while maintaining optimum motor performance by maintain the correct alignment of moving parts.

The motor, upon actuation moves an actuation arm that is pivotally attached to a connection arm. The aforementioned connection arm transfers the movement produced by the motor to the decoy. One of the innovations taught in this patent application is the utilization of connection arms that can be attached to a decoy at a position customized by the user. Further, this innovation offers the user the ability to utilize a wide variety of connector types to facilitate the decoy/connection arm interface. Permanent, non-permanent and temporary connector types are envisioned in the application of this technology. Exemplary types of decoy connections include, but are not limited to, Velcro, tape, glue, hook & loop, screws, nails, eyelet, magnets, mechanical pressure and other similar connection mechanisms known in the art. Combining the ability to change the angle of the motor to the mounting bar in combination with being able to position the connection arm which transfers movement to the decoy at virtually any location on or in the decoy offer a tremendous amount of different decoy movements. Further, the ability to easily remove the motor and the connection arms from a decoy, enable the utilization of a single actuation system on a variety of different decoy systems or the ability to easily make in field adjustments due to changing environmental conditions or pursuance of specific behavioral characteristics. As many hunting enthusiasts pursue different game over the different hunting seasons, the ability to use a single animation system over a variety of different decoys is a valuable and enabling attribute. Further, this innovation offers customizable decoy animation in a lightweight package, easing deployment of multiple systems and logistical considerations particularly related to large spreads and/or when the deployment location is far afield.

### BRIEF DESCRIPTION OF THE DRAWINGS

FIG. 1 shows a cutaway view of the motor assembly.

FIG. 2 shows a side view of a motor assembly mounted perpendicular to a mounting bar.

FIG. 3 shows a side view of a motor mounted parallel to a mounting bar.

FIG. 4 shows a side view of a motor angle adjuster mounting device.

FIG. 5 shows a side view of a second motor assembly angle adjuster mounting device.

FIG. 6a shows side view of locking hook and loop attachment.

FIG. 6b shows a side view of magnet attachment.

FIG. 6c shows side view of hook and loop attachment.

FIG. 6d shows side view of coiled wire and screw attachment.

FIG. 7a shows side view of Velcro attachment.

FIG. 7b shows a side view oft connector attachment.

FIG. 7c shows a side view of wire loop attachment.

FIG. 7d shows a side view of pop rivet attachment.

FIG. 8 shows side view of an electrically animated full body duck decoy.

FIG. 9 shows a side view of an electrically animated goose windsock decoy.

FIG. 10 shows a side view of an electrically animated full body turkey decoy.

FIG. 11 shows a side view of an electrically animated coyote decoy.

FIG. 12 shows a non electrical motor assembly.

FIG. 13 shows a non electrically animated full body duck decoy.

### DETAILED DESCRIPTION OF THE INVENTION

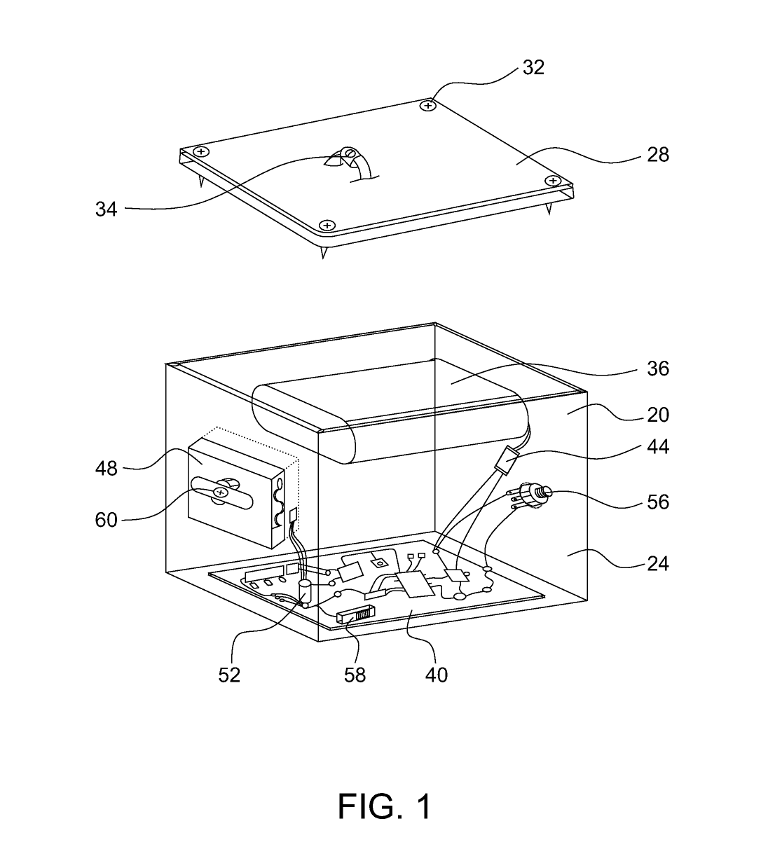

Referring to FIG. 1 shows a cutaway view of a motor assembly (20). Though different motors can be used, in this embodiment, a servo motor is used. The motor assembly (20), includes of a motor assembly box (24) and a motor assembly lid (28) which attaches to said motor assembly box (24) by 4 motor assembly box screws (32). Attaching said motor assembly lid (28) to said motor assembly box (24) results in a structurally sound assembly capable of including a gasket thereby enabling environmental protection to the components housed within. The motor assembly lid (28) includes a motor assembly mounting device (34), which in this embodiment is a hose clamp. It should be understood that other motor assembly mounting device means are envisioned and contemplated within the scope of this innovation and preferred embodiments are described later in this disclosure. Further, mounting devices envisioned include both those dictating a specific angle as well as those capable of securing a motor assembly at an angle defined by the user. Both systems will be described below. Said motor assembly mounting device (34), can be loosened and repositioned vertically along a mounting bar (not shown) at the discretion of the user.

Within the motor assembly box (24) is housed an electrical generating source (36), for instance a battery. Said electrical generating source (36) is connected to an electrical circuit (40) via a battery connection wire assembly (44). Said battery connection wire assembly (44) facilitates repeated connection and disconnection with both the electrical generating source (36) and the electrical circuit (40). In some embodiments, said electrical circuit (40) is capable of communication and augmentation of function and functionality via remote communication. Exemplary embodiments of remote communication include RF, Bluetooth and other wireless remote communication means known in the art. The ability to repeatedly connect and disconnect allows changing of the electrical generating source and the electrical circuit at the discretion of the user. This facility further enables easy upgrading of componentry. Said electrical circuit (40) is in electrical communication with the motor (48) via the motor connection wire assembly (52), which facilitates repeated connection and disconnection between the electrical circuit (40) and the motor (48). The ability to repeatedly connect and disconnect allows changing of the motor, or use of other motor system if used, and the electrical circuit at the discretion of the user. A charging port (56) is in electrical communication with the electrical circuit (40) and the electrical generating source (36). Said charging port (56) facilitates charging of said the electrical generating source (36) as is known in the art. Charging ports and charging systems, both hardwired and wireless, are known in the art and are considered to be applicable and in many cases desirable in the practical implementation of this innovation. An on/off switch (58) is in electrical communication with the electrical circuit (40), motor (48) and electrical generating source (36) enabling standard power on and power off to said motor (48) and electrical circuit (40) as is known in the art. It should be noted that said on/off switch (58) can be positioned elsewhere in regards to the electrical circuit or electrical generating source (36) without degradation of its operation.

Said motor (48) is mounted in the motor assembly box (24) such that said motor connection wire assembly (52) is positioned in the interior of the motor assembly box (24) and the actuation arm (60) is positioned on the exterior of the motor assembly box (24). When the motor is energized, the drive shaft of the motor (not shown) moves in a predefined arc, about its axis, resulting in movement of the actuation arm (60), which is connected to the aforementioned drive shaft.

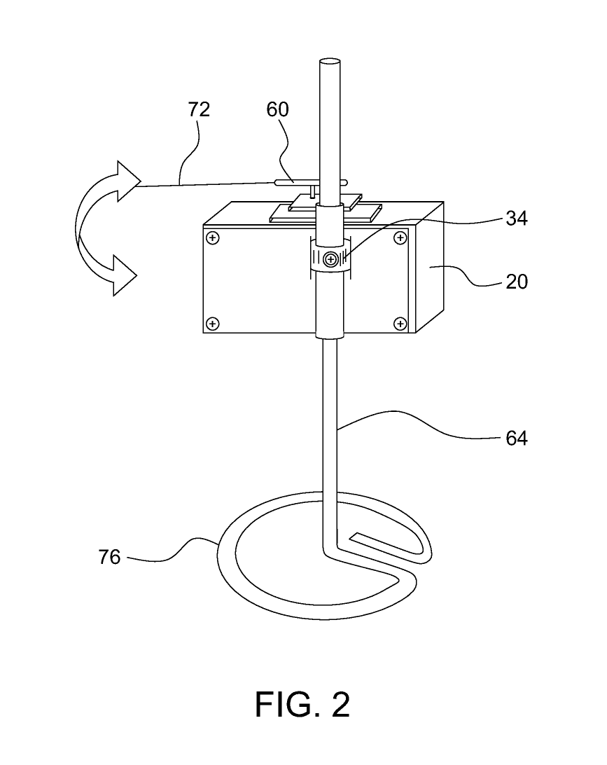

Referring to FIG. 2, a motor assembly (20) is shown attached in a perpendicular manner to a mounting bar (64). Though the mounting bar shown in FIG. 2 is of the type placed on the ground, it should be understood that the innovation is applicable to other types of mounting bars and showing this specific mounting bar should not be construed as a limitation. In this embodiment, the motor assembly (20) is attached to the mounting bar (64) by a motor assembly mounting device (34), which in this case is a hose clamp. Said motor assembly mounting device (34) can be loosened and repositioned vertically along the mounting bar (64) and tightened repeatedly at the discretion of the user.

Upon actuation, the motor assembly (20), via the motor not seen, moves the actuation arm (60) in a predetermined manner, the power being supplied through an electrical circuit. In general, the movement of the actuation arm is parallel to the length side of the motor assembly (20). The actuation arm (60) is pivotally connected to the first end of a connection arm (72). The second end of said connection arm (72), not shown, is connected to the decoy, not shown, thereby facilitating a physical connection to the motor (48), not shown, capable of transferring movement produced by said motor to the decoy.

As the motor assembly (20) is mounted on the mounting bar (64) such that the actuation arm (60) is parallel to the mounting bar base (76) of the mounting bar (64), the resulting movement of the actuation bar (60) is therefor also parallel to said base. In other embodiments of this innovation, said motor assembly (20) is mounted at an angle to said mounting bar (64) resulting in a very wide array of available planes of movement. Maintaining alignment or force upon the actuation arm in the same plane as it is designed enables optimal energy transfer and minimizes detrimental torque on the motor and/or parts of the motor (i.e. drive shaft and bearings). The ability to mount the motor assembly at a variety of angles to the mounting bar insures that the resulting alignment does not incur undue torque or misalignment with the motor action. This aspect of the innovation will be further described later in this disclosure.

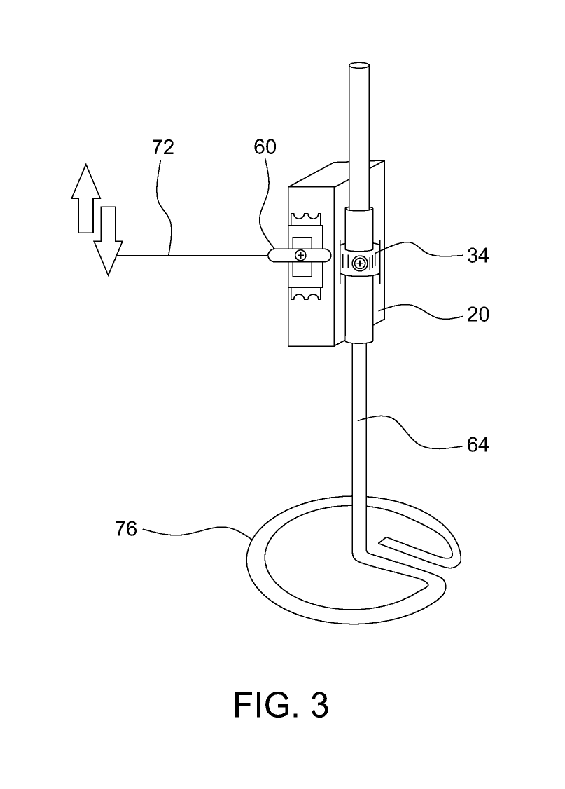

Referring to FIG. 3, a motor assembly (20) is shown attached in a parallel manner to a mounting bar (64). Though the mounting bar shown in FIG. 3 is of the type placed on the ground, it should be understood that the innovation is applicable to other types of mounting bars and showing this specific mounting bar should not be construed as a limitation. In this embodiment, the motor assembly (20) is attached to the mounting bar (64) by a motor assembly mounting device (34), which in this case is a hose clamp. Said motor assembly mounting device (34) can be loosened and repositioned vertically along the mounting bar (64) and tightened repeatedly at the discretion of the user.

Upon actuation, the motor, not shown, in the motor assembly (20) moves the actuation arm (60) in a preprogrammed manner, the power being supplied through an electrical circuit. In general, the movement of the actuation arm is substantially parallel to side of the motor assembly (20) upon which the motor attaches to the actuation arm. The actuation arm (60) is pivotally connected to the first end of a connection arm (72). The second end of said connection arm (72), not shown, is connected to the decoy, not shown, thereby facilitating a connection to the motor (48), not shown, capable of transferring movement produced by said motor to the decoy. As the motor assembly (20) is mounted on the mounting bar (64) such that the actuation arm (60) is parallel to the mounting bar (64), the resulting movement of the actuation bar (60) is also parallel to the mounting bar (64).

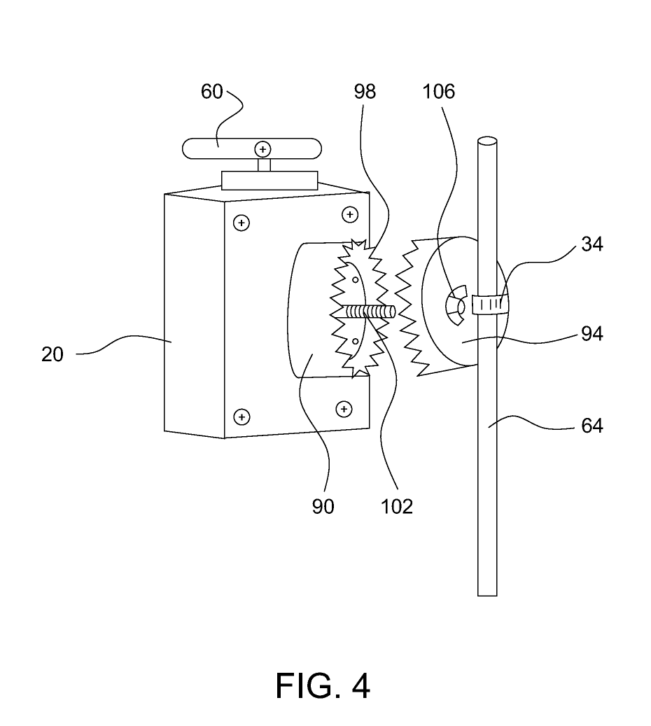

The ability to position the motor assembly, and hence the actuation arm at a variety of angles to said mounting bar enables a very large variety of resulting movements of the animated decoy without producing detrimental stress on the motor or drive mechanism used for actuation. Referring now to FIG. 4, which shows a motor assembly (20) capable of being mounted on a mounting bar (64) at a variety of different angles. A motor angle adjuster, in this embodiment, is comprised of two separate components; the motor angle adjuster motor side (90) and the motor angle adjuster mounting bar side (94). The motor angle adjuster motor side (90) is secured to the motor assembly (20) and the motor angle adjuster mounting bar side (94) is secured to the mounting bar (64). The two separate components of the motor angle adjuster mesh with one another at a variety of different angles, thereby enabling positioning and subsequent movement of the actuation arm over a wide variety of angular planes and hence movement of the decoy, or parts of the decoy, at over a wide variety of angular planes. That is, by mounting the motor assembly (20) at an angle to the mounting bar (64), the movement of the actuation arm (60) will also be at the same angle and hence results in transferring said movement to the decoy at the same angle without incurring undue stress on the motor or motor's mechanisms. Enabling movement at a variety angles or angular planes allows a user a vast array of movements with a single motor assembly. Further, the ability for a user to customize the specific angle of movement enables said user to customize not only individual decoys but also a plethora of individual decoys with different movements resulting in a more natural array of movements across a spread of decoys.

The two separate pieces of the motor angle adjuster, in this embodiment, mesh together by the aid of matched but opposing teeth (98). The two separate pieces of the motor angle adjuster are held together by a screw (102) and matching wing nut (106), which upon threading and tightening result in mechanically strong meshing that effectively locks the desired angle in place. Loosening of the screw (102) and matching wing nut (106) combination allows adjustment of the angle plane of movement at the discretion of the user. It should be noted that other means of defining and securing a particular angle are contemplated within this disclosure and the description of meshed teeth is used to convey the concept of changing the angle of the motor assembly in relation to the mounting bar/decoy and should not be construed as limiting. Other exemplary systems which can facilitate this functionality include flat surfaces compressed one upon the other, angular surfaces compressed one upon the other, magnetic materials which can be engaged one upon the other, pliable systems and the like.

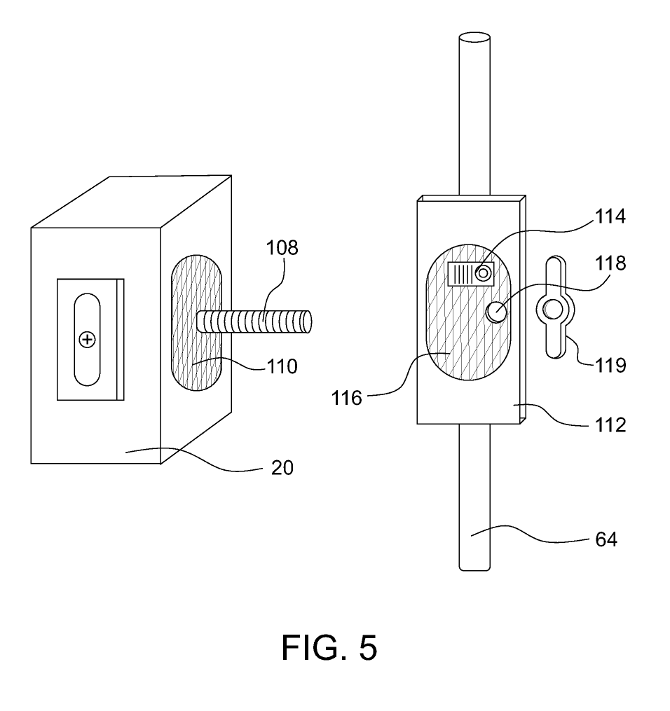

Referring now to FIG. 5, which shows a motor assembly (20) capable of being mounted on a mounting bar (64) at an angle, or fractions of an angle, defined by a user. The motor assembly angle adjuster, in this embodiment, is comprised of motor mounting screw (108) and a motor side rubber mount (110), which are both attached to the motor assembly (20). A mounting plate (112) is attached to the mounting bar (64) using, in this embodiment, a hose clamp (114) as previously described. A mounting bar side rubber mount (116) is secured to said mounting plate (112). A pass through hole (118) of a diameter enabling said motor mounting screw (108) to pass through both the mounting bar side rubber mount (116) and the mounting plate (112) is located offset of the mounting bar (64), thereby allowing unfetter access for the motor mounting screw (108) to pass through the pass through hole (118) in an unobstructed manner. A motor mounting screw nut (119) secures the motor assembly (20) to the mounting plate (112) by attaching to the motor mounting screw (108) as is known in the art. Both rubber mounts are mounted such that upon securement, they are positioned opposed to one another such that they touch and secure the user defined desired angle. In this embodiment, the use of two matched rubber mounts and a screw securement system enables a user to define any angle the user wishes. The ease of securement and re-adjustment of the angle allows rapid and easy adjustments in the field as well as rapid and easy removal of the motor assembly at the will of the user.

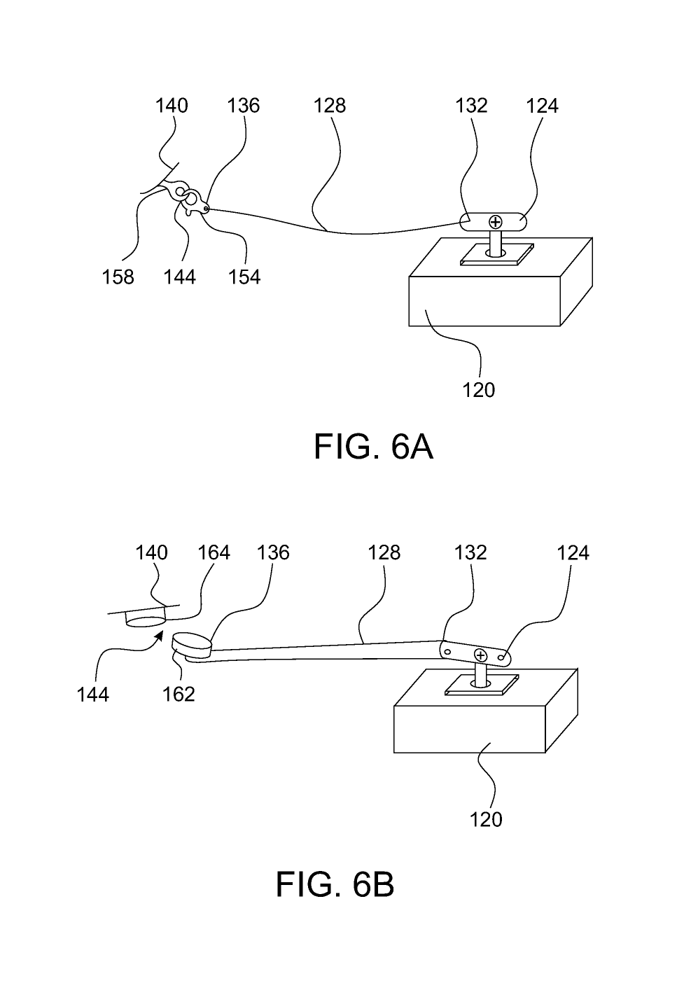

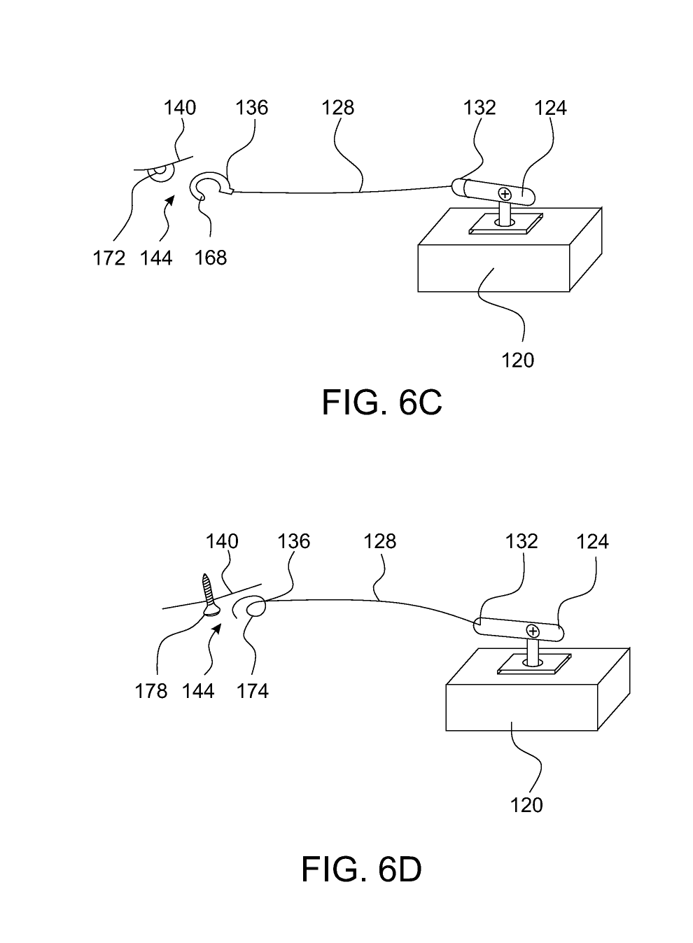

Referring now to FIG. 6 which shows a number of different connection arm to decoy connections. A motor assembly (120) connected to an actuation arm (124) drives a connection arm (128) as previously described. The actuation arm (124) is pivotally connected to the first end of a connection arm (132). Said connection arm (128) can be comprised of any suitable material provided that it is capable of conveying movement produced by the motor assembly (120) to a decoy. Exemplary connection arm materials include, but are not limited to; metal, wood, plastic, wire and in some embodiments string, rope or textiles. Exemplary connection arm shapes include, but are not limited to; rods, bars, cylinders, flat geometries, round geometries, oval geometries or hoses. The second end of said connection arm (136), is connected to the decoy (140) by what is termed the decoy connection assembly (144) thereby facilitating a connection to the motor assembly (120) capable of transferring movement produced by said motor assembly (120) to the decoy (140).

The decoy connection assembly (144), from said second end of said connection arm (136) to the decoy (140), can be permanent or temporary as desired by a user. In an exemplary embodiment of the innovation, said decoy connection assembly (144) is positioned at a location on a decoy at the discretion and at a location defined by the user. In a further exemplary embodiment of the innovation, said decoy connection assembly (144) is temporary, thereby allowing a user to reposition the location of the decoy connection assembly (144) to a different position on the decoy (140) at the discretion and at a location defined of the user. All of the figures described in FIG. 6 have the same components other than the decoy assembly (144).

Referring to FIG. 6A, the decoy connection assembly (144) is comprised of at least two separate components, the connection arm connection (154) and the decoy connection arm connection (158). It should be understood that in preferred embodiments the two portions of the decoy connection assembly (144) can be attached and separated from one another. In some embodiments, the two portions of the decoy connection assembly (144) are mated to one another in that they fit distinctly with each other as a specified pair. In a preferred embodiment of the innovation, said two portions of the decoy connection assembly (144) are not specifically mated to one another in that the connection arm connection (154) can be attached to different and separate decoy connection arm connections (158) thereby allowing a single connection arm to be subsequently connected to different decoy connections. It is envisioned that a single connection arm connection (154) can be used to connect with multiple individual at different times or a multitude of decoy connection arm connections (158) simultaneously at the discretion of a user. Multiple decoy connections can be singular in that a connection arm connects to a specific decoy connection where a decoy has multiple specific decoy connections, which can be chosen by a user, or that a single connection arm can simultaneously connect to multiple decoy connections.

In an exemplary embodiment of the innovation, said decoy connection assembly (144) FIG. 6A is embodied by a locking eyelet system comprised of a connection arm connection (154) which is a locking eyelet and a decoy connection arm connection (158) which is an receiving eyelet.

In another exemplary embodiment of the innovation, said decoy connection assembly (144) FIG. 6B is embodied in a pair of magnets, magnet A (162) and magnet B (164) that have a polarity attractive to one another.

In another exemplary embodiment of the innovation, said decoy connection assembly (144) FIG. 6C is embodied in hook (168) and loop (172) system.

In another exemplary embodiment of the innovation, said decoy connection assembly (144) FIG. 6D is embodied in coiled wire loop (174) and screw (178) system.

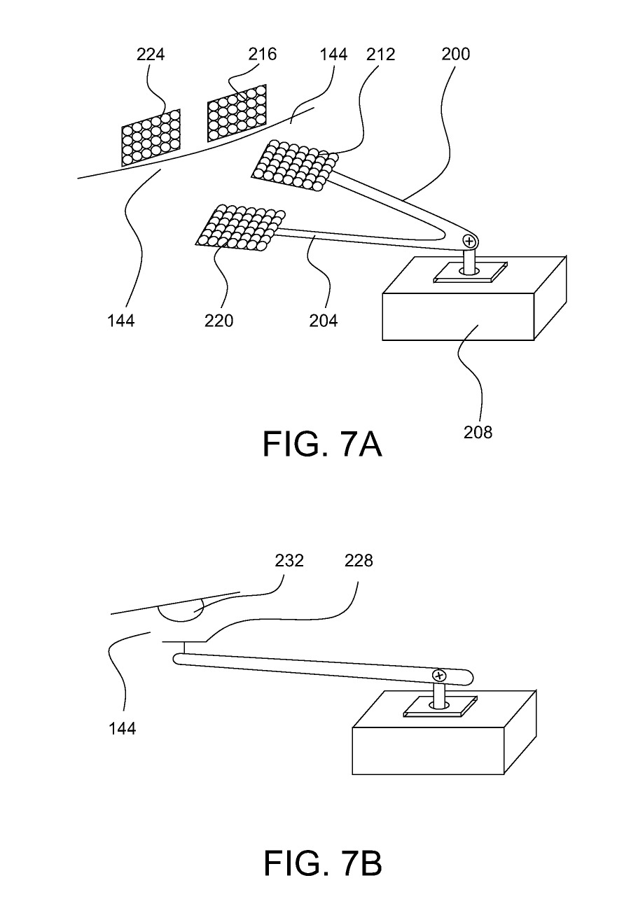

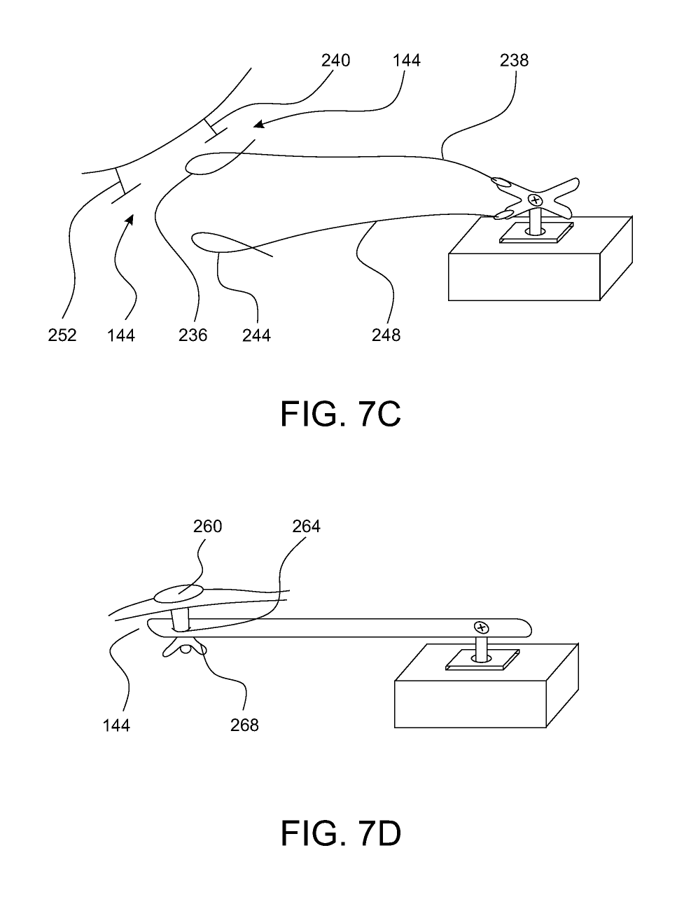

Referring now to FIG. 7. In another exemplary embodiment of the innovation, said decoy connection assembly (144) FIG. 7A is facilitated by the use of Velcro. FIG. 7a shows two connection arms, connection arm A (200) and connection arm B (204) being driven by a single motor assembly (208). Connection arm A (200) has a connection arm A connection (212) that connects to the decoy connection arm A connection (216). Connection arm B (204) has a connection arm B connection (220) that connects with a decoy connection arm B connection (224).

In another exemplary embodiment of the innovation, said decoy connection assembly (144) FIG. 7B is embodied in t connector (228) as the connection arm connector and a glue connector (232) as the decoy connection arm connector.

In another exemplary embodiment of the innovation, said decoy connection assembly (144) FIG. 7C is facilitated by first wire loop (236) as the connection arm connector of a first wire connection arm (238) and first loop t connector (240) and a second wire loop (244) as the connection arm connector of a second wire arm (248) and a second loop t connector (252). In this embodiment, the first wire loop (236) attaches to the first decoy loop connector (240) and the second wire loop (244) connects to the second decoy loop connector (252). In other embodiments of the innovation, the first wire loop (236) attaches to the second decoy loop connector (252) and the second wire loop (244) connects to first decoy loop connector (240). It should be noted that in this embodiment the wire loops, first wire loop (236) and the second wire loop (244), do not need to securely connect to the decoy body in order to facilitate the translation of animation from the motor assembly to the decoy. Physical pressure of the wire loops against a decoy surface is sufficient to impart said animation. In a preferred embodiment, wire loop systems of the type shown in FIG. 7C, positioned against but not secured to a decoy body, with no need for a loop connector, are particularly applicable to windsock decoys. Wire loop systems, with no loop or other type of decoy connection, applied to windsock decoys also provide a physical support for the windsock body with or without animation. This aspect is described in more detailed further in the disclosure.

In another exemplary embodiment of the innovation, said decoy connection assembly (144) FIG. 7D is embodied by a pop rivet (260) attached through the connection arm at a hole in said connection arm (264) and secured in position by a pop rivet connector (268).

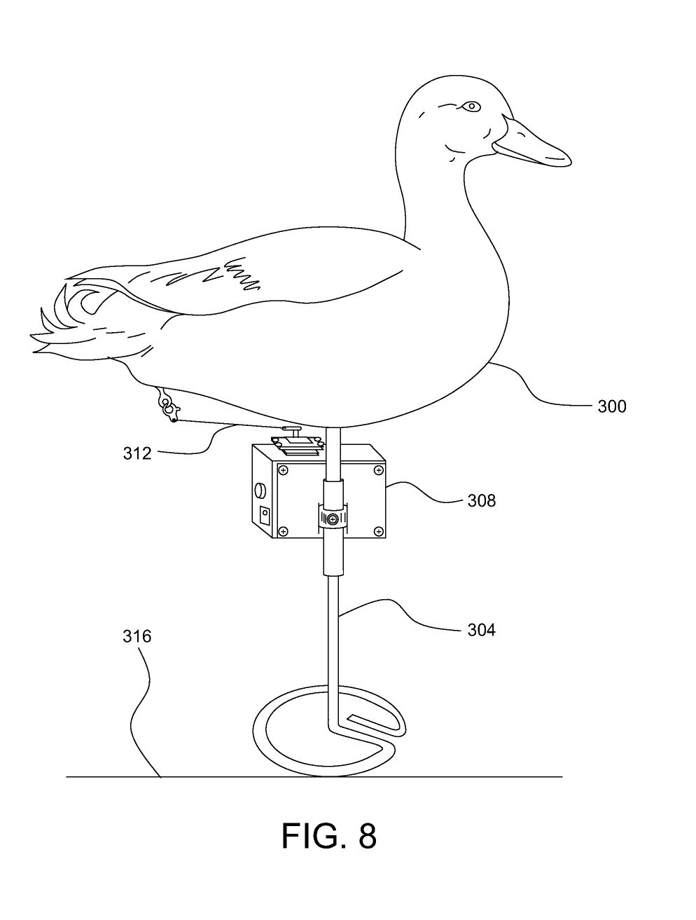

FIG. 8 shows a full body duck decoy (300) positioned on a mounting bar (304). A motor assembly (308) is secured to said mounting bar (304) such that an actuation arm (312) moves substantially parallel to the ground (316).

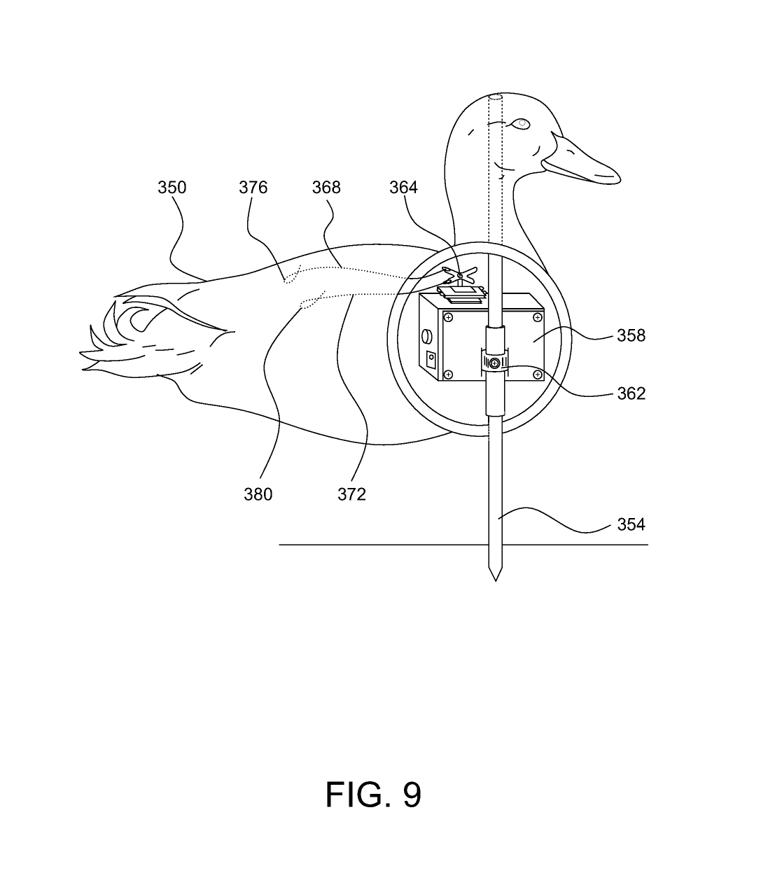

FIG. 9 shows a windsock goose decoy (350) positioned on a mounting bar (354). The motor assembly (358) is secured to the mounting bar (354) by a hose clamp (362) as previously described. In this preferred embodiment, the actuation arm (364) moves two connection arms, windsock connection arm 1 (368) and windsock connection arm 2 (372). It should be understood that more than two connection arms can be operated from a single actuation arm and that the use of two connection arms should not be viewed as a limitation and that more than two connection arms can be used. The use of two motor driven actuation arms, with each actuation arm capable of being positioned at the discretion of the user enables customizable animation of windsock decoys without the requirement of wind. Given that many decoy spreads number in the 10's, 100's and in some cases 1,000's, the ability to animate windsock decoys enables the use of these lightweight decoys regardless of wind condition. It should also be pointed out that the use of the described motorized connection arms does not interfere nor negate animation supplied by air movement. Indeed, it can supplement animation without impeding wind produced decoy movements.

In this embodiment, windsock connection arm 1 (368) and windsock connection arm 2 (372) not only supply customized animation but also support the body portion of the windsock decoy such that the form produced is consistent with that of a real animal. That is, rather than a flaccid sock, the sock is supported by the connection arms such that it looks like an actual physical body. Further, in this embodiment the connection arm decoy ends, windsock connection arm 1 decoy side 1 (376) and windsock connection arm 2 decoy side (380) are not secured to the windsock decoy (350) and are allowed to float against the interior of the windsock decoy. Allowing said connection arm decoy sides to float enables realistic animation of the decoy and negates crumpling or folding of the windsock material, thereby maintaining a natural appearance.

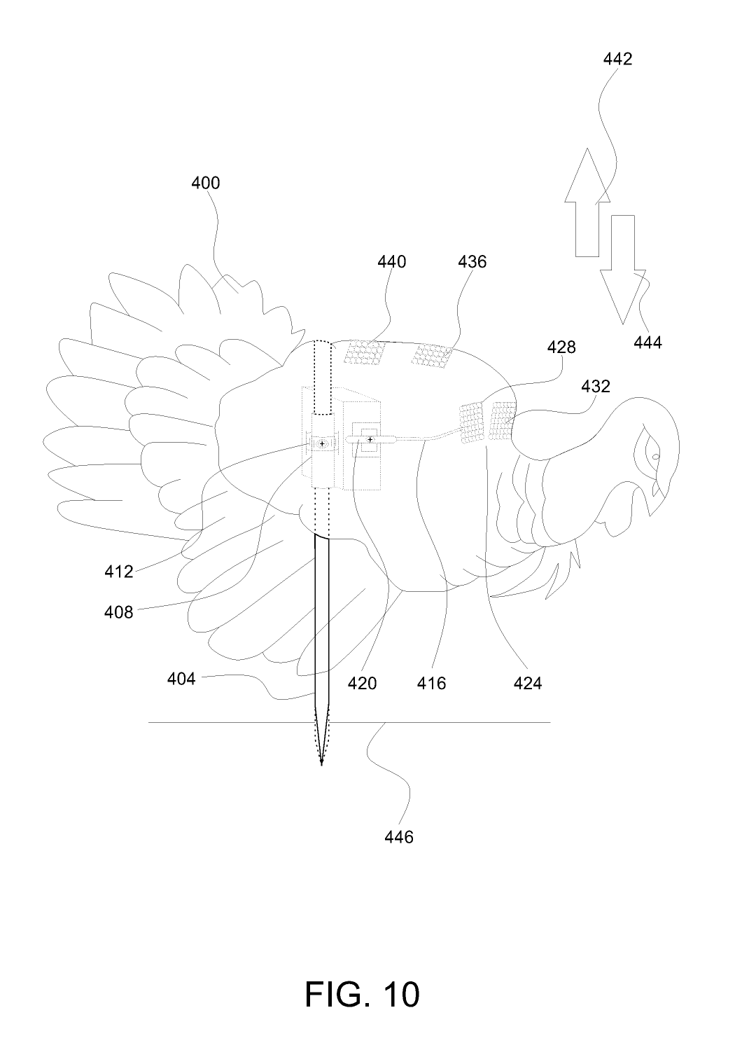

FIG. 10 shows a full body turkey decoy (400) mounted on a mounting bar (404). Said mounting bar (404), in this embodiment, is a stake positioned such that one end is securely positioned in the ground and the opposite end facilitates connection with the decoy. A motor assembly (408) is mounted to said mounting bar (404) by a hose clamp (412). A connection arm (416) facilitates transference of movement from the actuation arm (420) to a first decoy attachment (424) by way of two Velcro strips, Velcro strip 1 (428) securely attached to said connection arm (416) and Velcro strip 2 (432) which is securely attached to the inside of said full body turkey decoy (400). Upon securement of the two Velcro strips to one another, actuation of the motor assembly (408), said full body goose decoy (400) moves in response. Two other Velcro strips, Velcro strip 3 (436) and Velcro strip 4 (440) can be seen mounted on the inside of the decoy enabling quick and easy change of resulting animation without the need to change the motor assembly (408). In this embodiment, upon actuation, the full body turkey decoy (400) moves up (442) and down (444) relative to the ground (446).

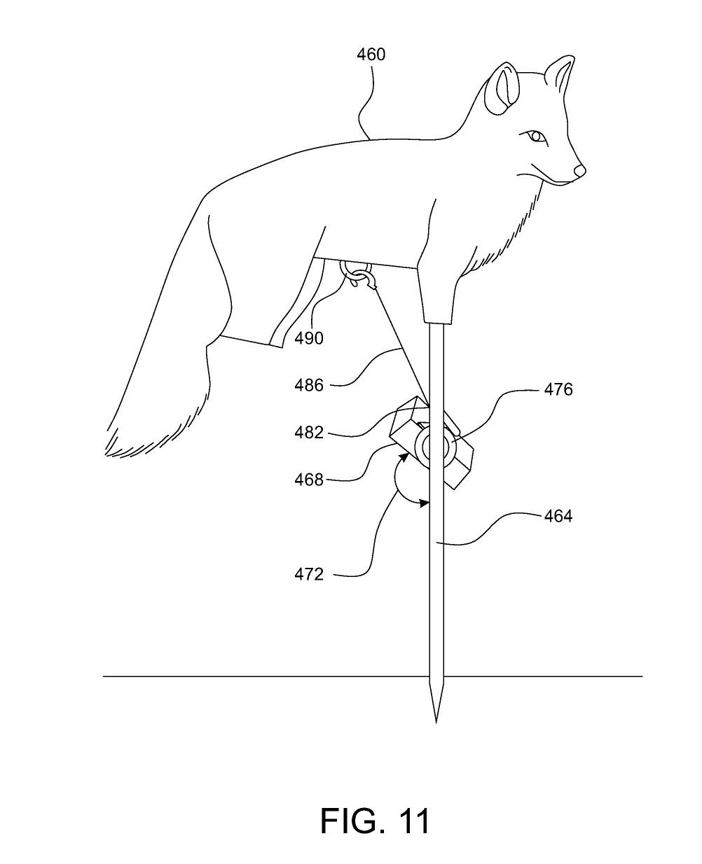

FIG. 11 shows a full body coyote decoy (460) mounted on a mounting bar (464). A motor assembly (468) is mounted at a specific angle (472) defined by and positioned by a user. Said motor assembly (468) is mounted using motor angle adjuster (476) as described in FIG. 5. The actuation arm (482) is pivotally connected to the connection arm (486), which is connected to the full body coyote decoy (460) at a decoy connection (490) thereby enabling efficient transference of movement from the motor assembly to the full body coyote decoy (460). The ability to mount a motor assembly at a specific angle (472) further enables a simple motor system to provide animation consistent with a real animal. That is, the angle can be selected such that the resulting motion is consistent with that of a real animal given the local terrain or environment. Further, the ability to mount and adjust the angle of the motor assembly also enables a vast amount of subsequent movements easily and simply.

Though the disclosure to this point has been directed to motor assemblies that utilize electrically activated motors, animation of decoys can also be achieved with motors actuated by non electrical power sources. In a preferred embodiment, a motor that utilizes a spring or multiple springs as the energy source is used rather than a battery powered electric motor as described earlier in this disclosure. Animated decoys utilizing energy supplied by a spring powered motor operate similarly as described above other than the energy source and type of motor being used to power the animating system. We define motor as a machine that produces motion or power for doing work. In this case, the work is defined as animation of a decoy. Connection arms, mounting systems and the flexibility enabled by the user positioning of motor assemblies and connection arm locations are the same. The only difference being that the electrical power source and associated electrical power source infrastructure are replaced with a spring powered motor.

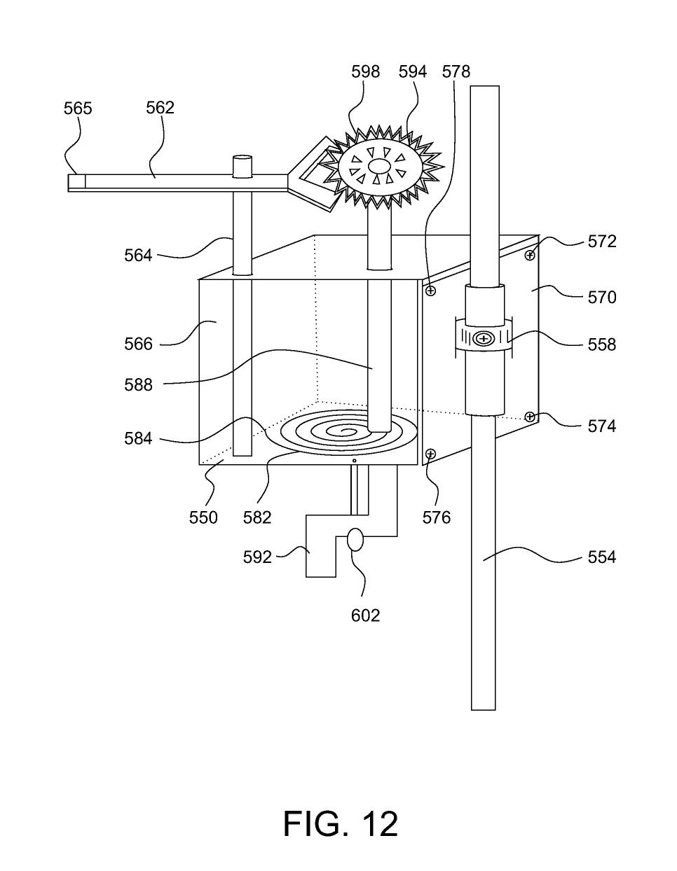

Referring now to FIG. 12, shows a non electrical motor assembly (550) attached to a mounting bar (554) by a motor assembly mounting device (558) which in this embodiment is a hose clamp as previously described. Said motor assembly mounting device (558) can be loosened and repositioned vertically along the mounting bar (554) and tightened repeatedly at the discretion of the user as previously described. It should be further understood that a non electrical motor assembly (550) can be attached to a mounting bar (554) in a horizontal or vertical fashion as previously described and is further amenable to be mounted using mounting mechanisms capable of angle adjustments as previously described. By horizontal and vertical fashion we refer to the relationship of the escapement arm (562) to the base of the mounting bar as previously described. The specific mounting mechanism depicted in FIG. 12 is used for explanatory purposes and should not be construed as a limitation.

The non electrical motor assembly (550), includes of a non electrical motor assembly box (566) and a non electrical motor assembly lid (570) which attaches to said non electrical motor assembly box (566) by 4 non electrical motor assembly box screws; non electrical motor assembly box screw 1 (572), non electrical motor assembly box screw 2 (574), non electrical motor assembly box screw 3 (576) and non electrical motor assembly box screw 4 (578). Attaching said non electrical motor assembly lid (570) to said non electrical motor assembly box (566) results in a structurally sound assembly capable of including a gasket thereby enabling environmental protection to the components housed within.

Within the non electrical motor assembly box (566) is housed a non-electrical energy generating source. In a preferred embodiment, said non-electrical energy generating source powers an escapement wheel, commonly referred to as an escapement system. Escapement systems are well known in the art and are commonly associated with timepieces where they provide the required periodic movements. In this embodiment, said non-electrical energy generating source is a single spring (582). In other embodiments, multiple springs can be used thereby enabling an increased amount of mechanical energy which can enable increased amounts of movement, movement of heavier decoys/decoy parts or increased time of movement, or combinations thereof. The end of said spring (582) farthest from the spring center is attached via a spring securement bolt (584) or similar securement device to the non electrical motor assembly box (566) as is known in the art. In some embodiments the end of the spring (582) farthest from the spring center can, by spring or mechanical force, be secured in a non-moving position without the use of a spring securement bolt (584). These types of securement systems are known in the art and are contemplated within the scope of this innovation. The opposite end of the spring, that is, the spring end closest to the center of the spring curvature, is secured to a post (588). A number of spring to post securement mechanisms are known in the art include; bolts, rivets, pass through holes which secure the spring via mechanical pressure etc. Said post (588) extends above and below said non electrical motor assembly box (566) by approximately 1″. Further, said post (588) can be moved vertically up and down through the box by approximately 1″. Said vertical movement enables winding of the spring and engagement of the escapement wheel (594) at the discretion of the user. It should be understood that the measurement of 1″ is not a limitation, rather an example of a working system. As previously described, said spring (582) is attached to said post (588) and is attached in a manner which allows said vertical up and down movement without diminishing the springs ability to provide energy as is known in the art.

At the end of the post (588) opposite the post handle (592) is attached an escapement wheel (594). Escapement wheels are known in the art and come in a variety of different materials and material combinations (i.e. metal, plastic, wood etc.), all types are deemed appropriate for the innovation. In this embodiment, said escapement wheel (594) is driven by force supplied from said spring (582). The escapement wheel, by virtue of its design, results in a periodic movement releasing a tooth of the escapement's wheel, allowing the escapement arm (562) to toggle back and forth by a fixed amount. Said escapement arm (562) pivots back and forth due to it's mounting on an escapement arm support bar (564) which is securely mounted to said non electrical motor assembly box (566). The resulting regular periodic advancement moves the escapement arm (562) back and forth at a steady rate. An escapement arm decoy connection (565) is located on the end of the escapement arm (562) opposite the end that interacts with the escapement wheel (594). The different decoy connections previously described in this disclosure are amenable to being used with the escapement arm (562) to connect to the decoy (not shown).

Said post (588) has a post handle (592) which enables easy winding of said spring (582) as is known in the art. In short, the post (588) can be disengaged from the escapement wheel (594) by way of the posts' vertical movement, the spring (582) can be wound, the post handle (592) can be engaged with the post handle securement (602) thereby preventing the unwinding of the spring until such time the system is actuated such that the escapement wheel can operate as is known in the art.

Though an Anchor escapement is depicted in FIG. 12, it should be understood that other types of escapements based systems for instance; Verge, Cross-beat, Graham or deadbeat, Pin wheel, Detent or Chronometer, Horizontal or Cylinder, Duplex, Lever, Grasshopper, Coaxial, Constant, Hip toggle and Electromechanical Escapements are envisioned as applicable to the teachings of this disclosure.

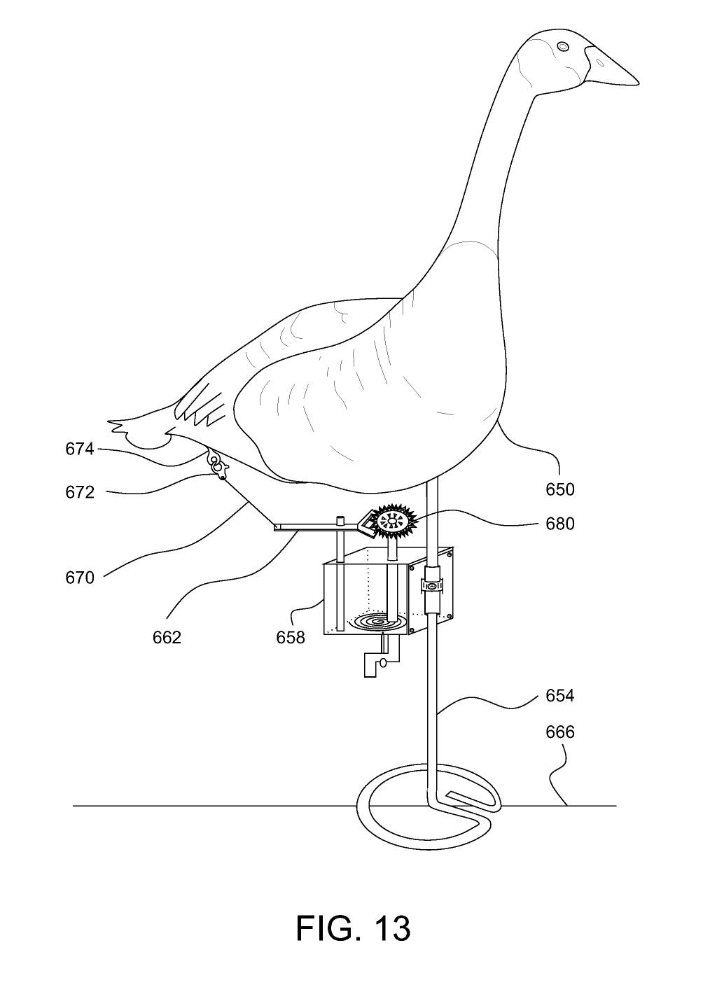

FIG. 13 shows a full body duck decoy (650) positioned on a mounting bar (654). A non electrical motor assembly (658) is secured to said mounting bar (654) such that a first escapement arm (662) moves substantially parallel to the ground (666). The second end of said first escapement arm (662) is attached to a first end of a second escapement arm (670). Attached to the second end of said second escapement arm (670) is a hook (672). Said hook (672) is attached to a loop (674) as is known in the art. Said loop (674) is attached to the decoy (650). Upon actuation of the escapement wheel (680), the aforementioned escapement arms move resulting in animation of the decoy (650).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### NUMERICAL IDENTIFIERS

motor assembly (20)
motor assembly box (24)
motor assembly lid (28)
motor assembly box screws (32)
motor assembly mounting device (34)
electrical generating source (36)
electrical circuit (40)
battery connection wire assembly (44)
motor (48)
motor connection wire assembly (52)
charging port (56)
on/off switch (58)
actuation arm (60)
mounting bar (64)
connection arm (72)
mounting bar base (76)
motor angle adjuster motor side (90)
motor angle adjuster mounting bar side (94)
matched but opposing teeth (98)
screw (102)
matching wing nut (106)
motor mounting screw (108)
motor side rubber mount (110)
mounting plate (112)
hose clamp (114)
mounting bar side rubber mount (116)
pass through hole (118)
motor mounting screw nut (119)
motor assembly (120)
actuation arm (124)
connection arm (128)
first end of a connection arm (132)
second end of said connection arm (136)
decoy (140)
decoy connection assembly (144)
connection arm connection (154)
decoy connection arm connection (158)
magnet A (162)
magnet B (164)
hook (168)
loop (172)
coiled wire loop (174)
screw (178)
connection arm A (200)
connection arm B (204)
single motor assembly (208)
connection arm A connection (212)
decoy connection arm A connection (216)
connection arm B connection (220)
decoy connection arm B connection (224)
t connector (228)
glue connector loop (232)
first wire loop (236)
first wire connection arm (238)
first loop t connector (240)
second wire loop (244)
connection arm connector of a second wire arm (248)
a second loop t connector (252)
pop rivet (260)
connection arm (264)
pop rivet connector (268)
full body duck decoy (300)
mounting bar (304)
motor assembly (308)
actuation arm (312)
ground (316)
windsock goose decoy (350)
mounting bar (354)
motor assembly (358)
hose clamp (362)
actuation arm (364)
windsock connection arm 1 (368)
windsock connection arm 2 (372)
windsock connection arm a decoy side 1 (376)
windsock connection arm 2 decoy side (380)
full body turkey decoy (400)
mounting bar (404)
motor assembly (408)
hose clamp (412)
connection arm (416)
actuation arm (420)
first decoy attachment (424)
Velcro strip 1 (428)
Velcro strip 2 (432)
Velcro strip 3 (436)
Velcro strip 4 (440)
up (442)
down (444)
ground (446)
full body coyote decoy (460)
mounting bar (464)
motor assembly (468)
specific angle (472)
motor angle adjuster (476)
actuation arm (482)
connection arm (486)
decoy connection (490)
non electrical motor assembly (550)
mounting bar (554)
motor assembly mounting device (558)
escapement arm (562)
escapement arm support bar (564)
escapement arm decoy connection (565)
non electrical motor assembly box (566)
non electrical motor assembly lid (570)
non electrical motor assembly box screw 1 (572)
non electrical motor assembly box screw 2 (574)
non electrical motor assembly box screw 3 (576)
non electrical motor assembly box screw 4 (578)
spring (582)
spring securement bolt (584)
post (588)
post handle (592)
escapement wheel (594)
post handle securement (602)
full body duck decoy (650)
mounting bar (654)
non electrical motor assembly (658)
first escapement arm (662)
ground (666)
second escapement arm (670)
hook (672)
loop (674)
escapement wheel (680)

What is claimed is:

1. An animated decoy comprising:
a decoy;
a motor assembly containing at least an electric motor, an electrical generating source capable of energizing said motor and an electrical circuit in communication with said electrical generating source and said motor;
a mounting bar suitable for securing at least one motor assembly;
a mounting mechanism capable of securing said motor assembly to said mounting bar;
at least one connection arm having a first end and a second end;
wherein said motor is pivotally attached to the first end of said connection arm and said second end of connection arm is pivotally attached to said decoy.

2. The animated decoy of claim 1 wherein the decoy is a full body type decoy.

3. The animated decoy of claim 1 wherein the decoy is a shell type decoy.

4. The animated decoy of claim 1 wherein the decoy is a windsock decoy.

5. The animated decoy of claim 1 wherein said electrical circuit is programmed to provide a choreographed series of motions to said motor.

6. The animated decoy of claim 5 wherein said electrical circuit is in wireless communication with a transmitter capable of initiating or changing said choreographed series of motions.

7. The animated decoy of claim 1, wherein said mounting mechanism can secure said motor assembly to said mounting bar at angle defined by a user.

8. The animated decoy of claim 1 wherein said second end of connection arm can be attached and detached at the discretion of a user.

9. The animated decoy of claim 1 wherein said second end of connection arm can be attached and detached at a decoy position defined by a user.

10. The animated decoy of claim 1, where said connection arm comprises multiple pieces of individual segments pivotally connected to one another.

11. The animated decoy of claim 1, where said motor actuates a plurality of connection arms.

12. The animated decoy of claim 1, where said electric motor is a servo motor.

13. An animated decoy comprising:
a decoy;
a motor assembly containing at least a motor, an electrical generating source capable of energizing said motor and an electrical circuit in communication between said electrical generating source and said motor;
a mounting bar suitable for securing at least one motor assembly;
a mounting mechanism capable of securing said motor assembly to said mounting bar;
wherein said mounting mechanism can be mounted on said mounting bar at an angle defined by a user;
wherein said motor assembly can be positioned at an angle to said mounting bar at an angle defined by a user;
at least one connection arm having a first end and a second end;
wherein said motor is pivotally attached to the first end of said connection arm and said second end of connection arm secured to said decoy in a position defined by a user.

14. The animated decoy of claim 13, where said motor is a servo motor.

15. The animated decoy of claim 13, where said second end of connection arm can be repeatedly attached and detached at the discretion of a user.

16. The animated decoy of claim 13, wherein said second end of connection arm can be attached and detached at a position on the decoy defined by a user.

17. An animated decoy comprising:
a decoy;
a motor assembly containing at least one spring an escapement wheel actuated by said spring(s);
a mounting bar suitable for securing at least one motor assembly;
a mounting mechanism capable of securing said motor assembly to said mounting bar;
at least one escapement connection arm having a first end and a second end;
wherein one end of said escapement connection arm is actuated by said escapement wheel and
said second end of said escapement connection arm being pivotally attached to said decoy.

18. The animated decoy of claim 17, wherein the decoy is a full body type decoy.

19. The animated decoy of claim 17, wherein the decoy is a shell type decoy.

20. The animated decoy of claim 17, wherein the decoy is a windsock decoy.

21. The animated decoy of claim 17, wherein said mounting mechanism can secure said motor assembly to said mounting bar at angle defined by a user.

22. The animated decoy of claim 17, wherein said second end of escapement connection arm can be attached and detached at the discretion of a user.

23. The animated decoy of claim 17, wherein said second end of escapement connection arm can be attached and detached at a decoy position defined by a user.

24. The animated decoy of claim 17, where said escapement connection arm comprises multiple pieces of individual segments pivotally connected to one another.

25. The animated decoy of claim 17, where said motor actuates a plurality of escapement connection arms.
